(19) United States
(12) Patent Application Publication
(10) Pub. No.: US 2010/0096023 A1
(43) Pub. Date: Apr. 22, 2010

(54) PRESSURE SURGE SENSOR AND ASSEMBLY INCLUDING SUCH A SENSOR AND A RUPTURE DISC

(76) Inventor: Christopher John Widdas, North Shields (GB)

Correspondence Address: STITES & HARBISON PLLC, 1199 NORTH FAIRFAX STREET, SUITE 900, ALEXANDRIA, VA, 22314, US

(21) Appl. No.: 12/581,462

(22) Filed: Oct. 19, 2009

(30) Foreign Application Priority Data
Oct. 19, 2008 (GB) 0819104.1

(51) Int. Cl. F16K 17/40

(52) U.S. Cl. 137/68.19; 137/68.11

(57) ABSTRACT

A pressure surge sensor has a body having a cylinder passage, a magnetically actuated electrical switch mounted on the body, and a piston member movable along the passage relative to the switch. The piston member carries a magnet. When the cylinder passage is coupled to a fluid pressure surge source, a fluid pressure surge applied causes the piston member to move along the cylinder passage relative to said switch, thereby actuating the switch. A breakable retainer element restrains the piston member against movement, and the piston is freely movable along the cylinder passage, after release by the retainer. The pressure surge sensor is suitable to be arranged downstream of a rupture disc, which releases overpressure of a pressurised apparatus, for example an extrusion apparatus, or a gas handling or gas storage system.

### FIELD OF THE INVENTION

This invention relates to a pressure surge sensor, which is particularly suitable for use with a pressure relief rupture disc. The invention also relates to an assembly comprising a pressure surge sensor and a pressure relief rupture disc.

### BACKGROUND TO THE INVENTION AND PRIOR ART

Rupture discs, also commonly known as bursting discs, are well known safety pressure relief devices, which are designed to rupture reliably at a predetermined pressure differential (rupture/burst strength).

It is well known in the many industries to provide such rupture discs for protecting pressure systems from over-pressurisation. One such rupture disc is for example disclosed in WO 03/031853. When the pressure at one side of the disc rises above a predetermined rupture strength, the disc ruptures thereby releasing pressure from the system. Typical applications are on reaction vessels and chambers, in the chemical, pharmaceutical and food industries.

Another application is to provide a warning detection system in an extrusion apparatus or gas handling or gas storage system, to give a warning of over-pressure.

It is also known in the art to provide a rupture disc with a rupture detector. WO 2005/054731 discloses a rupture disc type over-pressure detector having a rupture disc clamped at its flange between inlet and outlet pipe members. At the vent side of the device is mounted a magnet, its movement being sensed by a non-invasive sensor. When the pressure at one side of the disc rises above a predetermined rupture strength, the disc ruptures, thereby releasing pressure from the system and moving the magnet relative to the sensor. A signal is produced by the sensor, signalling that the rupture disc has ruptured.

### SUMMARY OF THE INVENTION

An object of the present invention is to provide an improved pressure surge detector, particularly a detector for use in combination with a rupture disc. A pressure surge detector, which provides an output signal when subjected to a pressure surge, must act reliably and quickly, when provided at the outlet side of a rupture disc. Particularly when the amount of pressurised gas released through the rupture disc, on rupture of the disc, is small, the sensor may be required to operate at relatively low pressure, for example 0.3 bar.

According to this invention there is provided a pressure surge sensor comprising

a body having a cylindrical passage,

a magnetically actuated electrical switch mounted on said body, and

a piston member movable along said passage relative to said switch, the piston member comprising a magnet,

said cylinder being adapted to be coupled to a fluid pressure surge source,

whereby a fluid pressure surge applied to said cylinder causes said piston member to move along said cylinder relative to said switch, thereby actuating said switch.

By the invention a device which is simple in construction and reliable in operation, even at low pressure, may be provided.

Preferably the sensor has a retainer restraining said piston member against movement along the cylinder from a first position in the cylinder relative to said switch, said retainer being adapted to release the piston member on application of a predetermined load to the piston member. The retainer may be a breakable element, adapted to be broken to release the piston member when said predetermined load is applied.

Preferably the piston is freely movable along the cylinder, after release by the retainer, no mechanical element applying a driving force opposing its movement.

The fluid pressure surge source is preferably a gas pressure surge source.

Preferably the body has one or more vent holes connecting said cylinder to the exterior, said vent hole or holes being located so as to be opened by the movement of the piston along the cylinder to allow release of gas pressure from the side of the piston to which the pressure surge is applied.

In a second aspect, the invention provides an assembly comprising a pressure surge sensor of the invention as described above and a rupture disc, the rupture disc being adapted to rupture at a predetermined rupture strength and arranged on rupturing to release a pressure surge to the pressure surge sensor.

The invention also provides a pressurised apparatus, such as an extrusion apparatus or gas handling or gas storage apparatus, having such an assembly.

### INTRODUCTION OF THE DRAWINGS

Non-limitative embodiments of the invention will now be described by way of example with reference to the accompanying drawings. In the drawings:

FIG. 1 is an isometric view of a first pressure surge sensor embodying the invention, with the housing body of the sensor cut away, to show the interior parts.

FIG. 2 is an end view on the left hand end of the pressure surge sensor of FIG. 1.

FIG. 3 is a side view of the pressure surge sensor of FIG. 1.

FIG. 4 is an isometric view of a second pressure surge sensor embodying the invention, cut along an axial section, to show interior parts.

FIG. 5 is a diagrammatic view of an assembly embodying the invention.

### DESCRIPTION OF PREFERRED EMBODIMENTS

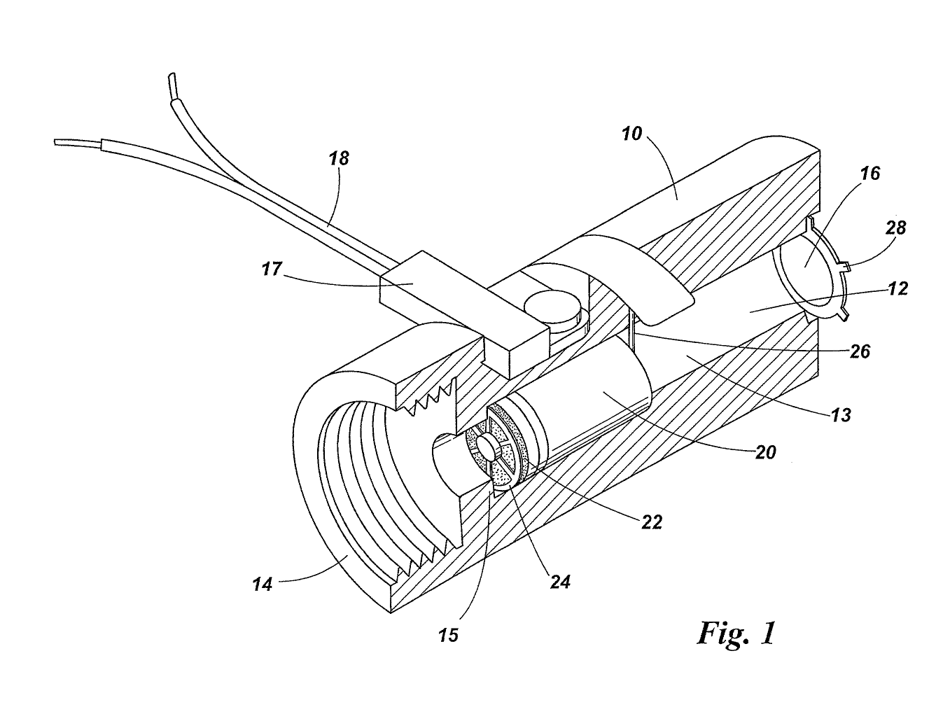

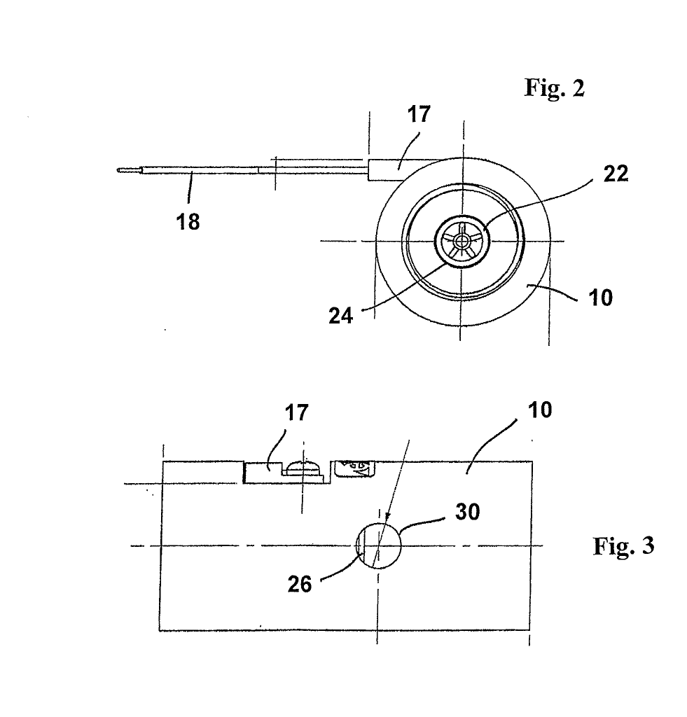

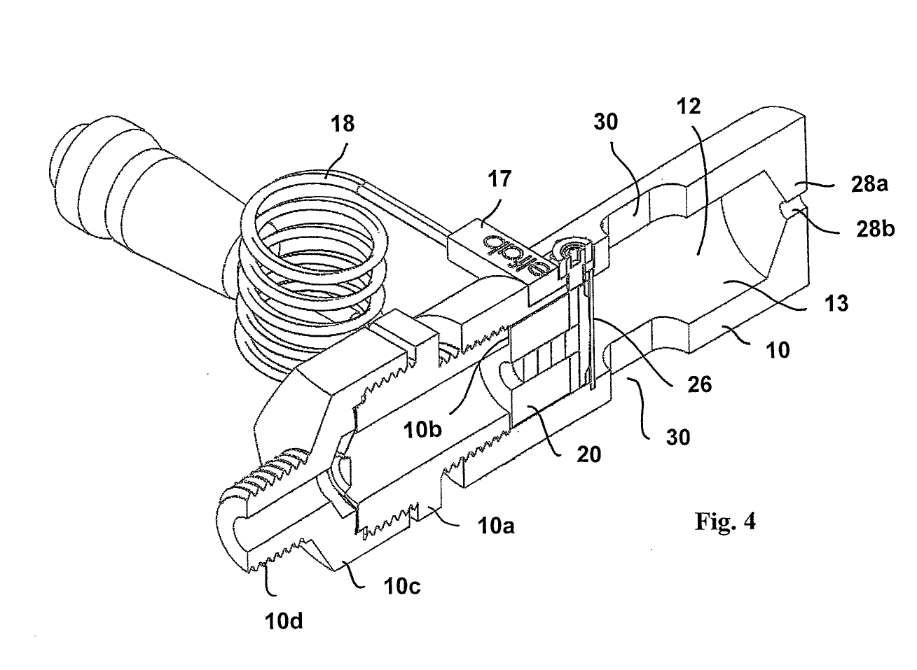

The pressure sensor embodying the invention shown in FIGS. 1 to 3 has a body in the form of a housing 10, which is made in one piece of suitable synthetic resin material, in the present case of nylon 6/6. Any other suitable non-magnetic material may be employed for this housing 10. The housing 10 has a central passage 12 which has a large screw-threaded portion 14 at one end, suitable to make connection with a complementarily threaded pipe. Apart from this large opening end 14, the central passage 12 is a circular-sectioned cylindrical shape passage 13 having a step 15 and extending to an open end 16 at the opposite end of the body 10.

On the exterior of the body 10, there is mounted a magnetically actuated reed switch 17 of a standard design, containing electrical contacts which are biased towards an open position and held in the closed position when subjected to a magnetic field provided by a magnet described below. Electrical wires 18 are connected to the switch 16, so that opening and closing of the contact in the switch 16 can be detected.

In the cylindrical passage 13 of the housing 10 a piston 20 is located, also having a circular cross-section and closely fitting within the passage 13, while being movable along the passage. At the first end of the piston 20, towards the large portion 14, there is mounted a felt washer 22 which is held in place by a steel disc 24 having openings through it and attached to the piston 20. The felt washer 22 provides a better seal of the piston 20 to the surface of the passage 13. A different form of piston ring may be provided to achieve a satisfactory seal between the piston 20 and the body 10, or no additional seal may be provided.

The piston 20 is made of a suitable synthetic resin material, in this case nylon 6/6, and holds within it a permanent bar magnet (not shown).

In the position shown in FIG. 1, movement of the piston 20 to the right hand side is optionally prevented by a piston retainer 26 which is a graphite rod and is easily broken. The load required to break this retainer 26 is small.

At the extreme right hand end of the passage 13 there is a fixed steel ring 28, which is removable, and which prevents the piston 20 from being driven out of the passage 13. On removal, it allows insertion and replacement of the piston 20.

As shown in FIG. 1, the piston is held against movement towards the open end 14 by the step 15 in the passage 13.

Spaced from the right hand side of the piston in its position shown in FIG. 1, the body 10 has laterally opening vents 30 extending from the passage 13 to the exterior peripheral face of the body 10.

Operation of the pressure surge sensor shown in the drawings is as follows. The normal rest position, before actuation of the sensor, is as shown in FIG. 1. In this position, the magnet within the piston 20 holds the contacts within the switch 16 in their closed position, allowing passage of current between the two wires 18. Typically a control device of the apparatus, to which the pressure surge sensor is fitted, continuously or periodically checks that the current flows, the contacts remaining closed. The piston 20 is held in place between the piston retainer 26 and the step 15. When a gas pressure surge having a pressure sufficiently above that of the atmosphere is applied at the end 14, the piston 20 is driven to the right as shown in FIG. 1 by the pressure differential over atmospheric pressure, breaking the retainer 26 and moving along the passage 12 at least until the vents 30 are uncovered, when excess pressure in the passage 12 can escape into the atmosphere. This movement of the piston 20 changes the magnetic field applying at the switch 16, allowing the contacts within the switch 16 to open, breaking the electrical connection between the two wires 18. This is sensed by the control device of the apparatus mentioned above, so that suitable action can be taken. A warning signal may be generated and/or the apparatus may be, for example, shut down.

After breakage of the optional retainer 26, no mechanical element provides a driving force opposing movement of the piston 20 along the passage 12. Only friction provides resistance to movement.

When used in conjunction with a rupture disc, the pressure surge sensor is connected, via the screw threaded opening end 14, to a pipe structure in which the rupture disc is mounted. The pressure surge sensor is thus on the downstream or low pressure side of the bursting disc. When the rupture disc operates by rupture, when its bursting strength is exceeded, a pressure surge passes through the bursting disc and operates the pressure surge sensor as described above. The rupture of the rupture disc is therefore detected.

For example, when the rupture disc is arranged in an extrusion machine, e.g. on a branch pipe connected to the pressurized chamber of the extrusion machine, or when the rupture disc is arranged connected in a gas handling or storage system to detect overpressure, the rupture disc is selected so as to rupture at the desired maximum operating pressure of the machine or system. Rupture of the rupture disc when this pressure is exceeded is detected by the pressure surge sensor. Operation of the pressure surge sensor is detected by the control device of the machine, which causes the machine to cease operation.

The pressure surge sensor is simple in operation, and is reliable, since the piston is able to move when subjected to a relatively low pressure differential. The device is not integral with the rupture disc mounting, and is easily mounted to an existing structure or incorporated in a new assembly.

The contacts of the switch 16 may alternatively be held in the open position by the magnetic field of the magnet in the piston 20, but the arrangement described above is more fail-safe because accidental cutting of the wire 18 is detected. In another embodiment, the switch 16 may be mounted at a different position on the body 10, so that the magnet 20 can moves past it or comes to a stop close to it, when the pressure surge causes movement of the magnet.

The device can be made of components which are capable of resisting relatively high temperatures, for example 100° C.

In the drawings, the cylinder passage 12 and the piston 20 are circular in cross-section, which is most convenient, but may be of other cross-section shape.

FIG. 4 shows a pressure surge sensor embodying the invention which is a modification of the sensor of FIGS. 1 to 3. Similar or identical parts are identified by the same reference numbers and will not be described again. This sensor differs from that of FIGS. 1 to 3 in several ways. Instead of the removable ring 29, the body 10 has an integral end 28a having a small hole 28b through it to allow air to escape. The piston 20 cannot be removed at this end of the body 10. At the left end in FIG. 4, the body 10 has a pipe portion 10a screw-threadedly engaged into the body 10 and providing an abutment face 10b which prevents the piston 20 from moving to the left from its normal rest position adjacent the optional breakable retainer 26. The pipe portion 10a has a connector 10c screw-threadedly engaged on it and having an exterior screw-thread 10d which is suitable for connection to a pipe or other vessel in which the pressure surge, to be detected, may occur. Removal of the pipe portion 10a from the body allows insertion, removal and replacement of the piston 20.

The operation of the sensor of FIG. 4 is the same as that of FIGS. 1 to 3.

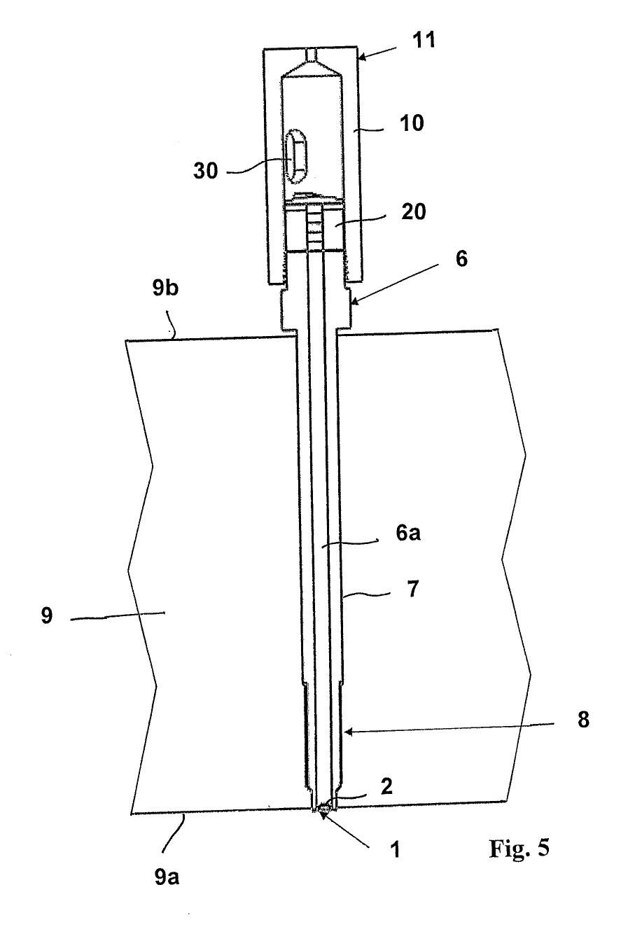

FIG. 5 shows diagrammatically an assembly of the invention, comprising the sensor of FIG. 4 indicated by reference numeral 11, a rupture disc assembly 1 and a wall of a pressurized apparatus, schematically indicated by reference numeral 9 having an internal face 9a at the high-pressure side and an external face 9b. The pressurized apparatus 9 is for example a conventional extrusion apparatus, e.g. for extrusion of plastics or metal, or is a pressurized tank or other vessel of a gas handling or gas storage system.

Attached to the front end of the body 10 of the sensor 11, by a screw-thread, is a tubular member 6 replacing the elements 10a and 10c of FIG. 4. The member 6 holds the disc unit having the disc 2 at its distal end and is sealingly engaged in a bore 7 through the wall 9 by a screw-thread 8.

The rupture disc assembly 1 shown is of a known type, such as described in GB-A-2285284, WO03/031853, WO2005/054731, WO2007/036719 and EP-A-1938007. The assembly 1 has a forward-acting rupture disc unit having a rupture disc 2 adapted to rupture at a predetermined pressure at the interior of the wall 9

When excess pressure in the pressurized apparatus 9, being protected by the rupture disc assembly 1, is applied to the inlet face of the disc 2, the disc 2 ruptures, releasing a pressure surge along the central bore 6a of the member 6 to the pressure surge sensor 11, which provides an electrical output signal, which may act as a warning and/or be used for control of the apparatus 9.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

What is claimed is:

1. A pressure surge sensor comprising
a body having a cylinder passage,
a magnetically actuated electrical switch mounted on said body, and
a piston member movable along said passage relative to said switch, the piston member comprising a magnet,
said cylinder passage being adapted to be coupled to a fluid pressure surge source,
whereby a fluid pressure surge applied to said cylinder passage causes said piston member to move along said cylinder passage relative to said switch, thereby actuating said switch.

2. A pressure surge sensor according to claim 1, having a retainer restraining said piston member against movement along the cylinder passage from a first position in the cylinder passage relative to said switch, said retainer being adapted to release the piston member on application of a predetermined load to the piston member.

3. A pressure surge sensor according to claim 2, wherein said retainer is a breakable element, adapted to be broken to release the piston member when said predetermined load is applied.

4. A pressure surge sensor according to claim 2, wherein said piston is freely movable along the cylinder passage, after release by the retainer, no mechanical element applying a driving force opposing its movement.

5. A pressure surge sensor according to claim 3, wherein said piston is freely movable along the cylinder passage, after release by the retainer, no mechanical element applying a driving force opposing its movement.

6. A pressure surge sensor according to claim 1, wherein the body has one or more vent holes connecting said cylinder passage to the exterior, said vent hole or holes being located so as to be opened by the movement of the piston along the cylinder passage to allow release of gas pressure from the side of the piston to which the pressure surge is applied.

7. An assembly comprising a pressure surge sensor and a rupture disc, the rupture disc being adapted to rupture at a predetermined rupture strength and arranged on rupturing to release a pressure surge to the pressure surge sensor,
said pressure surge sensor comprising
a body having a cylinder passage,
a magnetically actuated electrical switch mounted on said body, and
a piston member movable along said passage relative to said switch, the piston member comprising a magnet,
said cylinder passage being adapted to be coupled to a fluid pressure surge source,
whereby a fluid pressure surge applied to said cylinder passage causes said piston member to move along said cylinder passage relative to said switch, thereby actuating said switch.

8. An assembly according to claim 7, wherein said pressure surge sensor has a retainer restraining said piston member against movement along the cylinder passage from a first position in the cylinder passage relative to said switch, said retainer being adapted to release the piston member on application of a predetermined load to the piston member.

9. An assembly according to claim 8, wherein said retainer is a breakable element, adapted to be broken to release the piston member when said predetermined load is applied.

10. An assembly according to claim 9, wherein said piston is freely movable along the cylinder passage, after release by the retainer, no mechanical element applying a driving force opposing its movement.

11. A pressurised apparatus, for example an extrusion apparatus, or a gas handling or gas storage system, having an assembly comprising a pressure surge sensor and a rupture disc attached thereto for release of overpressure and detection thereof, the rupture disc being adapted to rupture at a predetermined rupture strength and arranged on rupturing to release a pressure surge to the pressure surge sensor,
said pressure surge sensor comprising
a body having a cylinder passage,
a magnetically actuated electrical switch mounted on said body, and
a piston member movable along said passage relative to said switch, the piston member comprising a magnet,
said cylinder passage being adapted to be coupled to a fluid pressure surge source,
whereby a fluid pressure surge applied to said cylinder passage causes said piston member to move along said cylinder passage relative to said switch, thereby actuating said switch.

12. A pressurised apparatus according to claim 11, wherein said pressure surge sensor has a retainer restraining said piston member against movement along the cylinder passage from a first position in the cylinder passage relative to said switch, said retainer being adapted to release the piston member on application of a predetermined load to the piston member.

13. A pressurised apparatus according to claim 12, wherein said retainer is a breakable element, adapted to be broken to release the piston member when said predetermined load is applied.

14. A pressurised apparatus according to claim 13, wherein said piston is freely movable along the cylinder passage, after release by the retainer, no mechanical element applying a driving force opposing its movement.
